(19) United States
(12) Patent Application Publication
(10) Pub. No.: US 2008/0250708 A1
(43) Pub. Date: Oct. 16, 2008

(54) Support for Supporting/Binding a Plant

(75) Inventor: Serge Remi Jamoneau, De Lier (NL)

Correspondence Address: SUGHRUE MION, PLLC, 2100 PENNSYLVANIA AVENUE, N.W., SUITE 800, WASHINGTON, DC, 20037, US

(73) Assignee: Priva Holding B.V., De Lier (NL)

(21) Appl. No.: 11/570,062

(22) PCT Filed: Jun. 8, 2004
(86) PCT No.: PCT/NL2004/000403

§ 371 Date: Feb. 29, 2008

(51) Int. Cl. A01G 9/12; A01G 17/06

(52) U.S. Cl. 47/47; 47/70

(57) ABSTRACT

Support for supporting or binding a plant. It is proposed to attach the plant to a support with the aid of attachment means such as a ring. This support extends essentially vertically and in order to absorb the forces acting in the vertical direction the position of the ring in the vertical direction must be fixed. By constructing the support with two longitudinal strands located some distance apart and traverse strands arranged some distance apart between them, intermediate spaces are created for confirming the ring therein. Optionally, the various features can be used in combination with clips. The support is, for example, attached to a horizontal span wire or to a vertical hook and the invention is employed in particular with tomatoes, peppers, cucumbers or aubergines or the other plants that are possibly to be bound.

The present invention relates to a support for supporting/binding a plant comprising an elongated part. Such a support is generally known in the form of twine in the state of the art. Such supports are used in the cultivation of, for example, vegetable crops such as tomatoes and (sweet) peppers. Such supports are fixed to the top of a cultivation area, such as a greenhouse. Such a fixing is, for example, a horizontal span wire. Such supports can be wound on a bobbin tied to the high wire and after attaching to the span wire are unrolled from the bobbin. The stem of the plant is then attached to the support. One of the possibilities for attachment is the use of rings. An example of a device for fitting rings is described in European application 903 976 in the name of Bas van Schie.

It is possible to prevent as far as possible the curling-in usually found with tomatoes and peppers by using such rings. Consequently, staff with little training are able to achieve attachment of the stem of the plant and the support at high speed. However, it is not possible by using rings to absorb forces acting vertically. The rings can be moved freely along the support or wire. Clips are used to fix the vertical position of the plant. Numerous proposals have been made for the design of such clips.

The advantage of the use of rings is that after use these can be removed with the plant. Preferably, the rings are made of iron with a thin coating of copper. When shredded these rings will rapidly disappear as a result of oxidation. Consequently, the removal costs for the plant are low. If clips are used, which generally are made of plastic, it is then necessary either to separate these from the plant to be removed or to require a higher price for the further processing thereof. Both actions lead to an increase in the price of removal at the end of cultivation. Moreover, purchasing clips increases the cost. Other means of attachment are possible, such as intertwining support and plant stem. This is a laborious method that requires trained staff and can lead to damage to the plant.

The aim of the present invention is to provide a support by means of which it is possible in a simple manner to fix the plant in the vertical direction as well.

This aim is realised with the support described above in that the support comprises two elongated spaced strands of twine, wherein the distance between said strands is between 3 and 15 mm and wherein transverse strands are arranged between said elongated strands and the distance between the transverse strands is between 2 and 20 mm. In this way a “ladder-like” construction of ladder cord is produced, it being possible, for example, for a ring to be confined in such an intermediate space. As a result of the transverse strands, vertical forces on the plant can be transmitted into the support. As a result, the support can achieve a load-bearing function even when simple rings are used. It will be understood that the way in which the transverse strands extend between the longitudinal strands is not important for the present invention. After all, all that is important is that in some way or other there is an opening between the transverse strands for fitting attachment means, such as a ring.

If this opening is chosen to be relatively large, for example in the form of a rectangle with sides of 4-7 mm, a guide pin of a ring-fitting device can be inserted in such a space. In this way the position of the support with respect to the ring-fitting device is fixed. All that is still necessary then is to fix the position of the stem with respect to the ring-fitting device and the ring can be fitted in a simple manner. It will be understood that rings can be fitted particularly quickly in this way.

It will also be understood that the use of clips is essentially superfluous, it being possible for the removal costs for the plant with rings therein to be low. It will be understood that the ring-fitting device can be provided with other positioning means in order to fix the position between support and ring-fitting device. The strand material preferably consists of a plastic material such as polypropene. More particularly, the material of the ring is biodegradable, as a result of which the removal costs for the plant with the remainders of the support can be even further reduced. Other materials are also possible. The support can be coloured of have various colours. The elongated strands are preferably made up of a number of filaments. A filament of an elongated strand branches off at each transverse strand in order to form the transverse strand and continues into the opposite longitudinal strand and then crosses back over to the first longitudinal strand at the following transverse strand. Other patterns can, of course, also be produced.

Furthermore, it is possible to position the ring-fitting device or other device for fitting attachment means with the aid of a robot (arm). In this case the stem of the plant can be sought automatically and brought together with the support, after which attachment takes place.

The present invention also relates to the combination of the support described above and attachment means such as a ring. Because the ring now has to take up loads in the vertical direction, it is preferable to make this somewhat stronger. This can be achieved, inter alia, in that the ends of the ring winding are made to overlap one another to a considerable extent. The composition of the material of the ring can also be adapted to the higher force that acts on the ring via the plant. It is possible that if an iron ring provided with a copper coating is used, (harmless) marks are produced on the stem of the plant. To prevent this it is possible no longer to provide the ring with a copper coating or to provide it with a thinner copper coating. In this case additional measures have to be taken to prevent problems with regard to oxidation during use. This can be achieved, for example, by making the ring of a material that forms an essentially impermeable oxide skin on oxidation. So-called Corten steel is mentioned as an example. It is found that such materials are absorbed in the soil after shredding and no special steps are needed when composting if such rings are present in the plant to be removed. The ring can also be provided with a plastic coating or can be made entirely of plastic. Other attachment means, such as clips, clamps and binder twine, can be used instead of a ring.

Moreover, by using two strands located some distance apart with transverse strands between them as the support, the incoming light is impeded as little as possible by the support and the harvest yield can be optimised.

The present invention also relates to a method for supporting/binding a plant comprising attaching a wound-up support for supporting/binding a plant to a high point, which support comprises two elongated spaced twine strands located, wherein the distance between the strands is between 3 and 15 mm and wherein transverse strands are arranged between said elongated strands and the distance between said transverse strands is between 2 and 20 mm, unwinding said support, bringing the plant to be bound and the support together and fitting attachment means acting between the support and the plant.

The invention will be explained in more detail below with reference to an illustrative embodiment shown in the drawing. In the drawing:

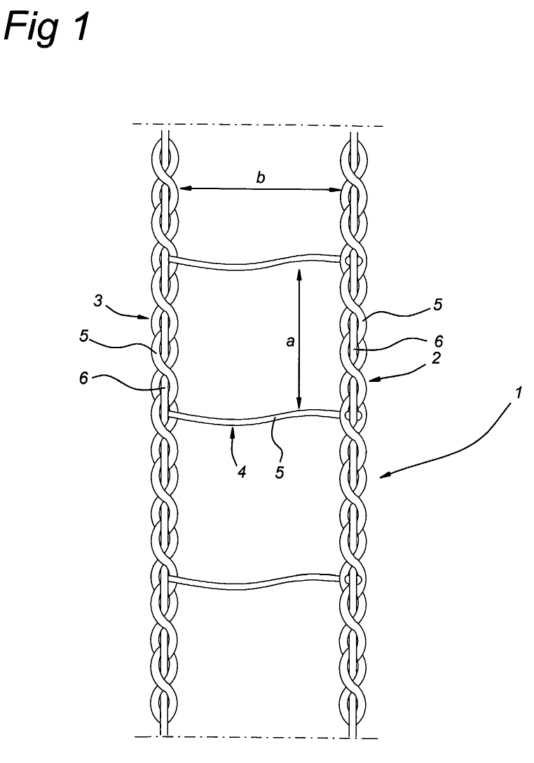

FIG. 1 shows a front view of the support according to the invention and

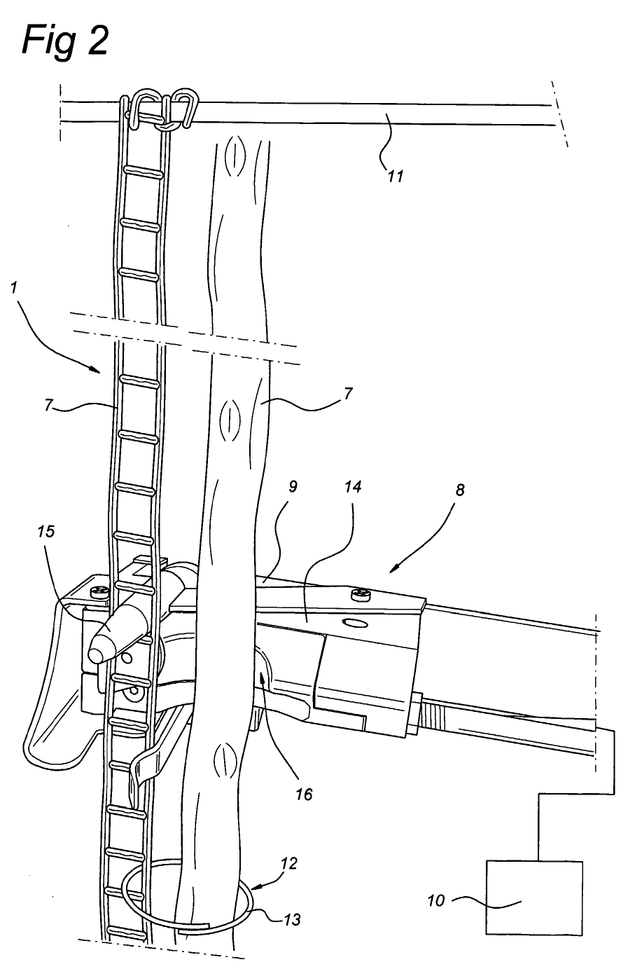

FIG. 2 shows a side view of the fitting of a ring under combination support/transverse strands.

In the figures the support according to the invention is indicated in its entirety by 1. This consists of two spaced longitudinal strands 2, 3. The spacing between these is indicated by b. This distance is between 3 and 15 mm and preferably between 4 and 6 mm and more preferentially is approximately 5 mm.

The longitudinal strands are coupled to one another by a transverse strand 4. The spacing between the transverse strands is indicated by a. This spacing a is between 2-20 mm and more particularly between 5 and 12 mm. In the example shown, the longitudinal spacing a is approximately 8 mm. The length of the support can be any length known in the state of the art. A length of approximately 15 metres is mentioned as an example. The strands can be made of any material, such as polypropene, polyethene or a biodegradable material.

Each longitudinal strand 2, 3 consists of filaments. There are at least two filaments 5, 6. With this arrangement the construction is such that at transverse strand 4 this filament 5 of, for example, longitudinal strand 2 forms this transverse strand, that is to say branches off from the longitudinal strand 2. After producing transverse strand 4, this filament continues into longitudinal strand 3 and can then be used again as transverse strand 4 in another location. Other weaving patterns are possible and, of course, it is possible to use a different number of filaments in both the longitudinal strands and transverse strands.

In FIG. 2, the stem of a plant that has to be positioned with the aid of the support is shown by 7. This positioning comprises both the horizontal and vertical position, that is to say the stem 7 is suspended from the support 1. For this purpose a horizontal span wire 11 is fitted, to which the top of the support is attached. Preferably, the support is wound on a bobbin such as the tomato hook known in the state of the art or tied to a high wire, as in the case of (sweet) peppers.

The support is made of a material such that if this is wound on a bobbin it unrolls easily without forming knots and hangs down in a flexible manner without additional measures having to be taken for this purpose.

After arranging the wires and the plants, the plant will have to be attached to the support in ever new positions as it grows. A so-called ring device 8 can be used for this purpose. This is shown diagrammatically only. Reference is made to EP 903 976 A1 for an example developed in detail. This device essentially consists of a feed in which a wire store is also present. This device can be carried on the back or on a trolley or in some other way. A fitting head constructed in a pistol-like manner is indicated by 9. This consists of a housing 14 from which a pin 15 extends, as well as construction for winding a ring. This construction is such that when it leaves the fitting head 9 the wire is given a slight curvature so that this then winds according to a circle. Moreover, guides that are not shown in detail are present for this purpose. After the ring has been sufficiently formed, that is to say the winding 13 of ring 12 covers a sufficient number of degrees, such as one and a half windings, the wire is cut through with the aid of a cutter device mounted on the fitting head 9.

As shown in FIG. 2, the pin 15 can be inserted precisely through the gap created by two spaced longitudinal strands 2, 3 and two strands 4 located some distance apart. As a result the positioning of the fitting head with respect to the support is fixed.

It can also be seen from FIG. 2 that there is a cavity 16 in housing 14 for accommodating the stem 7. In this way the user can insert pin 15 through the opening in the support and position the stem of the plant correctly in a single operation. By then activating the ring-forming process the stem 7 is fixed in both the horizontal and the vertical direction with respect to the support.

Clips can optionally also be added, but in principle this is not necessary.

Although the present invention has been described above with reference to the preferred embodiment, variants will be immediately apparent to those skilled in the art that are obvious after the above and fall within the scope of the appended claims. For instance, it is possible to combine the support according to the invention with conventional techniques, such as intertwining support and stem of the plant.

1-12. (canceled)

13. Support for supporting/binding a plant comprising two elongated strands of twine located some distance apart, wherein the distance between said strands is between 3 and 15 mm and wherein transverse strands are arranged between said elongated strands and the distance between the transverse strands is between 2 and 20 mm, said support being an elongated part and in that said strands comprises a number of woven filaments, wherein a first elongated strand comprises two filaments over a first section up to a first transverse strand, a second elongated strand some distance away comprises one filament up to said first transverse strand, one of said filaments of said first elongated strand forms said first transverse strand and extends from said first transverse strand to said second elongated strand.

14. Support according to claim 13, wherein said strand comprises a biodegradable material.

15. Assembly for supporting/binding a plant comprising a support for supporting/binding a plant comprising an elongated part, said support comprising two elongated strands of twine located some distance apart, wherein the distance (b) between said strands is between 3 and 15 mm and wherein transverse strands are arranged between said elongated strands and the distance (a) between the transverse strands is between 2 and 20 mm attachment means that are confined between the space delimited between the two elongated strands and two adjoining transverse strands and that are designed to engage on the stem of a plant, and a horizontal span wire to which the top of the support is fitted.

16. Assembly according to claim 15, wherein said attachment means comprise a ring.

17. Assembly according to claim 16, wherein said ring has overlapping ends in contact with one another.

18. Assembly according to claim 15, wherein said attachment means comprise a metal that oxidises in the environment, wherein the oxide skin thus formed is essentially oxygen-tight.

19. Assembly according to claim 15, wherein said attachment means comprise a clip.

20. Method for supporting/binding a plant comprising attaching a wound-up support for supporting/binding a plant to a high point, which support comprises two elongated twine strands located some distance apart, wherein the distance between the strands is between 3 and 15 mm and wherein transverse strands are arranged between said elongated strands and the distance between said transverse strands is between 2 and 20 mm, unwinding said support, bringing the plant to be bound and the support together and fitting attachment means acting between the support and the plant.

21. Method according to claim 20, wherein fitting said attachment means comprises fitting a ring extending around the stalk of the plant, which ring is confined between the space delimited between two elongated strands and two adjacent transverse strands of said support.

22. Method according to claim 20, wherein said plants are tomatoes, peppers, cucumbers or aubergines.
